(19) United States
(12) Patent Application Publication
(10) Pub. No.: US 2016/0294768 A1
(43) Pub. Date: Oct. 6, 2016

(54) ELECTRONIC DEVICE FOR PERFORMING COMMUNICATION USING DNS NAME AND METHOD THEREOF

(71) Applicant: Samsung Electronics Co., Ltd., Gyeonggi-do (KR)

(72) Inventor: Ashmath Bin Miyar KHAN, Gyeonggi-do (KR)

(73) Assignee: Samsung Electronics Co., Ltd.

(21) Appl. No.: 15/086,888

(22) Filed: Mar. 31, 2016

(30) Foreign Application Priority Data
Mar. 31, 2015 (KR) 10-2015-0045102

(51) Int. Cl. H04L 29/12; H04L 29/08

(52) U.S. Cl. CPC H04L 61/1511; H04L 67/141; H04L 61/6013

(57) ABSTRACT

An electronic device and method thereof is provided. The electronic device includes a processor configured to obtain a domain name system (DNS) name of another electronic device, a display circuit configured to display the DNS name, a user input receive circuit configured to receive a user input associated with the displayed DNS name, and a communication circuit configured to perform peer-to-peer communication with the other electronic device based on the user input.

### PRIORITY

This application claims priority under 35 U.S.C. §119(a) to Korean Patent Application Serial No. 10-2015-0045102, which was filed on Mar. 31, 2015, in the Korean Intellectual Property Office, the entire disclosure of which is incorporated herein by reference.

### BACKGROUND

1. Field of the Disclosure

The present disclosure relates generally to an electronic device for performing communication using a domain name system (DNS) name and a method thereof, and more particularly, to an electronic device for performing peer-to-peer communication with another electronic device corresponding to a DNS name based on a user input for the DNS name displayed on the electronic device, received from a user of the electronic device.

2. Description of the Related Art

With the development of information and communication technologies, network devices such as base stations have been installed in many locations. Electronic devices communicate data with other electronic devices over networks, thus allowing users to freely use networks.

Various types of electronic devices have provided a variety of functions following a recent trend in digital convergence. For example, smartphones communicate text messages using networks, support internet access functions, support music or video playback functions, and support image and video capturing functions using image sensors.

### SUMMARY

The present disclosure is made to provide at least the advantages described below.

Accordingly, an aspect of the present disclosure is to provide an electronic device for performing communication using a DNS name and a method thereof.

In accordance with an aspect of the present disclosure, an electronic device is provided. The electronic device includes a processor configured to obtain a domain name system (DNS) name of another electronic device, a display circuit configured to display the DNS name on a screen of the electronic device, a user input receive circuit configured to receive a user input associated with the displayed DNS name, and a communication circuit configured to perform peer-to-peer communication with the other electronic device based on the user input.

In accordance with another aspect of the present disclosure, a method performed in an electronic device is provided. The method includes obtaining a domain name system (DNS) name of another electronic device, displaying the DNS name on a screen of the electronic device, receiving a user input associated with the displayed DNS name, and performing peer-to-peer communication with the other electronic device based on the user input.

In accordance with another aspect of the present disclosure, a computer-readable medium storing instructions thereon is provided. The instructions may be set to obtain a domain name system (DNS) name of another electronic device, to display the DNS name on a screen of an electronic device, to receive a user input associated with the displayed DNS name, and to perform peer-to-peer communication with the other electronic device based on the user input.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system for performing communication using a DNS name according to an embodiment of the present disclosure;

FIG. 2 illustrates a phone book application displayed on a screen of an electronic device according to an embodiment of the present disclosure;

FIG. 3 illustrates a phone book application displayed on a screen of an electronic device according to an embodiment of the present disclosure;

FIG. 4 illustrates a configuration of an electronic device according to an embodiment of the present disclosure;

FIG. 5 is a flowchart illustrating a method for communicating with another electronic device using a DNS name according to an embodiment of the present disclosure;

FIG. 6 is a flowchart illustrating a method for obtaining state information of another electronic device using a DNS name according to an embodiment of the present disclosure;

FIG. 7 is a signal flow diagram illustrating a method for performing a chat service with another electronic device using a DNS name according to an embodiment of the present disclosure; and

FIG. 8 illustrates a configuration of an electronic device according to an embodiment of the present disclosure.

### DETAILED DESCRIPTION

Hereinafter, various embodiments of the present disclosure are described with reference to the accompanying drawings. However, the present disclosure is not limited to these specific embodiments, and includes all modifications and/or, equivalents and substitutions within the scope and technical range of the present disclosure. With respect to the descriptions of the drawings, like reference numerals refer to like elements, features, or structures.

Terms used in the present disclosure are used to describe specified embodiments and do not limit the scope of the present disclosure. The terms of a singular form may include plural forms unless otherwise specified. Unless otherwise defined herein, all the terms used herein, which include technical or scientific terms, may have the same meanings that are generally understood by a person skilled in the art. It will be further understood that terms, which are defined in a dictionary and commonly used, should also be interpreted as is customary in the relevant related art and not in an idealized or overly formal manner unless expressly so defined as such herein. In some cases, even if terms are terms defined in the specification, they may not be interpreted to exclude embodiments of the present disclosure.

Herein, the expressions “have”, “may have”, “include”, “comprise”, “may include”, and “may comprise” indicate existence of corresponding features (e.g., elements such as numeric values, functions, operations, or components) but do not exclude the presence of additional features.

The expressions “A or B”, “at least one of A or/and B”, or “one or more of A or/and B”, etc., used herein may include any and all combinations of one or more of the associated listed items. For example, the terms “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, etc., used herein, may refer to various elements irrespective of the order and/or priority of the corresponding elements, and do not limit the corresponding elements. The expressions may be used to distinguish one element from another element. For example, both “a first user device” and “a second user device” indicate different user devices from each other, irrespective of the order and/or priority of the corresponding elements. Accordingly, a first component may be referred to as a second component, and vice versa, without departing from the scope of the present disclosure.

When an element (e.g., a first element) is referred to as being “(operatively or communicatively) coupled with/to” or “connected to” another element (e.g., a second element), the first element can be directly coupled with/to or connected to the second element or an intervening element (e.g., a third element) may be present therebetween. In contrast, when the first element is referred to as being “directly coupled with/to” or “directly connected to” the second element, there are no intervening elements.

Depending on the context, the expression “configured to” as used herein may be used interchangeably with, for example, the expression “suitable for”, “having the capacity to”, “designed to”, “adapted to”, “made to”, or “capable of”. The term “configured to” does not mean only “specifically designed to”. Instead, the expression “a device configured to” may mean that the device is “capable of” operating together with another device or other components. For example, a “processor configured to perform A, B, and C” may mean a general-purpose processor (e.g., a central processing unit (CPU) or an application processor) which may perform corresponding operations by executing one or more software programs which stores a dedicated processor (e.g., an embedded processor) for performing a corresponding operation.

Electronic devices according to various embodiments of the present disclosure may include smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices (e.g., smart eyeglasses, head-mounted-devices (HMDs), electronic apparel, electronic bracelets, electronic necklaces, electronic appcessories, electronic tattoos, smart mirrors, or smart watches).

The electronic devices may also be smart home appliances such as televisions (TVs), digital versatile disk (DVD) players, audio players, refrigerators, air conditioners, cleaners, ovens, microwave ovens, washing machines, air cleaners, set-top boxes, home automation control panels, security control panels, TV boxes (e.g., Samsung HomeSync®, Apple TV®, or Google TV®), game consoles (e.g., Xbox® and PlayStation®), electronic dictionaries, electronic keys, camcorders, or electronic picture frames.

The electronic devices may also be various medical devices (e.g., various portable medical measurement devices (e.g., blood glucose meters, heart rate meters, blood pressure meters, or thermometers, etc.), magnetic resonance angiography (MRA) devices, magnetic resonance imaging (MRI) devices, a computed tomography (CT) device, scanners, or ultrasonic devices, etc.), navigation devices, global navigation satellite system (GNSS), event data recorders (EDRs), flight data recorders (FDRs), vehicle infotainment devices, electronic equipment for vessels (e.g., navigation systems, gyrocompasses, etc.), avionics, security devices, head units for vehicles, industrial or home robots, automatic teller machines (ATMs), point of sales (POSs) terminals, or Internet of things (IoT) devices (e.g., light bulbs, various sensors, electric or gas meters, sprinkler devices, fire alarms, thermostats, street lamps, toasters, exercise equipment, hot water tanks, heaters, boilers, etc.).

The electronic devices may also be parts of furniture or buildings/structures, electronic boards, electronic signature receiving devices, projectors, or various measuring instruments (e.g., water meters, electricity meters, gas meters, or wave meters, etc.). The electronic devices according to various embodiments of the present disclosure may be one or more combinations of the above-mentioned devices.

The electronic devices may also be flexible electronic devices.

Also, electronic devices are not limited to the above-mentioned devices, and may include new electronic devices according to new technology development.

Herein, the term “user” may refer to a person who uses an electronic device or may refer to a device (e.g., an artificial intelligence device) that uses an electronic device.

In the accompanying drawings, various embodiments of the present disclosure are described using a smartphone by way of example.

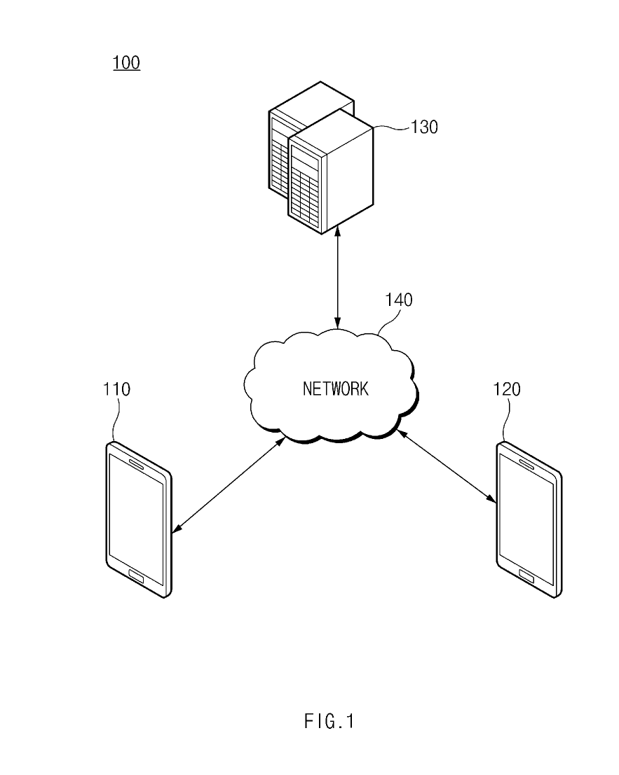

FIG. 1 illustrates a system for performing communication using a DNS name according to an embodiment of the present disclosure.

Referring to FIG. 1, the system 100 includes an electronic device 110 (e.g., a first electronic device), another electronic device 120 (e.g., a second electronic device), an external server 130, and a network 140.

The electronic device 110 may obtain a DNS name of the other electronic device 120. The DNS has been developed to convert a domain name of a host into a network address of the host or to convert a network address of the host into a domain name of the host. The DNS may convert a domain name, easily understood by people, into an identification number (e.g., an internet protocol (IP) address) with numerals to find an address of a specific computer (or any device connected to a network). For example, the DNS may be an internet domain address system, may convert a domain name of a main computer, such as www.example.com, into an IP address such as 192.168.1.0, and may provide routing information, in support of transport control protocol (TCP)/IP. In this case, www.example.com may refer to a DNS name. The DNS name may correspond to an IP version 4 (IPv4) or IP version 6 (IPv6).

There are a plurality of methods in which the electronic device 110 obtains the DNS name of the other electronic device 120.

For example, the electronic device 110 may obtain the DNS name of the other electronic device 120 based on a user input for inputting the DNS name of the other electronic device 120.

As another example, the electronic device 110 may receive the DNS name of the other electronic device 120 from the other electronic device 120 through the network 140. In this case, the DNS name of the other electronic device 120 may be sent from the other electronic device 120 to the electronic device 110 through local-area communication such as a near field communication (NFC) network or a Bluetooth (BT) network.

Alternatively, the DNS name of the other electronic device 120 may be sent in a text message from the other electronic device 120 to the electronic device 110 through a cellular network or a wireless-fidelity (Wi-Fi) network.

As another example, the electronic device 110, may receive the DNS name from the other electronic device 120 through a specific event. The specific event may include, for example, an incoming or outgoing call connection event, a short message service/multimedia message service (SMS/MMS) message transmit or receive event, a chat event through a 3^{rd} party application, between the other electronic device 120 and the electronic device 110. In this case, the other electronic device 120 may generate a message including its DNS name and may send the generated message to the electronic device 110. The generated message including the DNS name may be, for example, a message for establishing a session between the other electronic device 120 and the electronic device 110.

As another example, the electronic device 110 may obtain the DNS name of the other electronic device 120 from the external server 130. The external server 130 may be a server operated by a communication company, a server operated by an electronic device manufacturer, or an application server. If the electronic device 110 stores at least one information about the other electronic device 120 or a user, of the other electronic device 120, the external server 130 may send the DNS name of the other electronic device 120 to the electronic device 110 through synchronization, etc., according to the stored information.

The electronic device 110 may display the obtained DNS name on its screen and may perform peer-to-peer communication with the other electronic device 120 through a DNS server according to a user input for the displayed DNS name.

An IP address corresponding to the DNS name of the other electronic device 120 may be dynamically changed. In this case, the electronic device 110 may perform peer-to-peer communication with the other electronic device 120 through a dynamic DNS (DDNS).

The other electronic device 120 may perform peer-to-peer communication with the electronic device 110. In order to perform the peer-to-peer communication with the electronic device 110, the other electronic device 120 registers a DNS name and an IP address in advance in the DNS server. Also, the other electronic device 120 may send the DNS name of the other electronic device 120 to the electronic device 110.

The external server 130 may be a server operated by a communication company, a server operated by an electronic device manufacturer, or an application server. The external server 130 may send the DNS name of the other electronic device 120 to the electronic device 110 through synchronization, etc.

The electronic device 110, the other electronic device 120, and the external server 130 included in the system 100 for performing communication using the DNS name may connect with each other over the network 140. In this case, the network 140 may refer to a connection structure of exchanging information between nodes such as terminals and servers and may include wireless communication and wired communication. The wireless communication may use, for example, at least one of 3rd generation (3G), long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like, as a cellular communication protocol. Also, the wireless communication may include, for example, at least one of wireless-fidelity (Wi-Fi) communication, world interoperability for microwave access (WiMAX) communication, wireless gigabit (WiGig) communication, Bluetooth (BT) communication, near field communication (NFC), or global positioning system (GPS) communication, etc. The wired communication may include, for example, at least one of universal serial bus (USB) communication, high definition multimedia interface (HDMI) communication, recommended standard 232 (RS-232) communication, or plain old telephone service (POTS) communication, etc. Also, the network 140 may include a telecommunications network, for example, at least one of a computer network (e.g., a local area network (LAN), a wireless local area network (WLAN), a personal area network (PAN), or a wide area network (WAN)), the Internet, or a telephone network.

According to an embodiment of the present disclosure, it may be unnecessary for a DNS name of the electronic device 110 to be different from the other electronic device 120. For example, the electronic device 110 may perform peer-to-peer communication with the other electronic device 120 using only the DNS name of the other electronic device 120, irrespective of the DNS name of the electronic device 110.

The electronic device 110 may obtain an IP address of the other electronic device 120 and may perform peer-to-peer communication using the IP address. Herein, if the IP address of the other electronic device 120 is dynamically changed, it may be more effective that the electronic device 110 communicates with the other electronic device 120 using the DNS name of the other electronic device 120.

The DNS name of the other electronic device 120 may be registered as contact information about the other electronic device 120 or the user of the other electronic device 120 in a phone book application, etc.

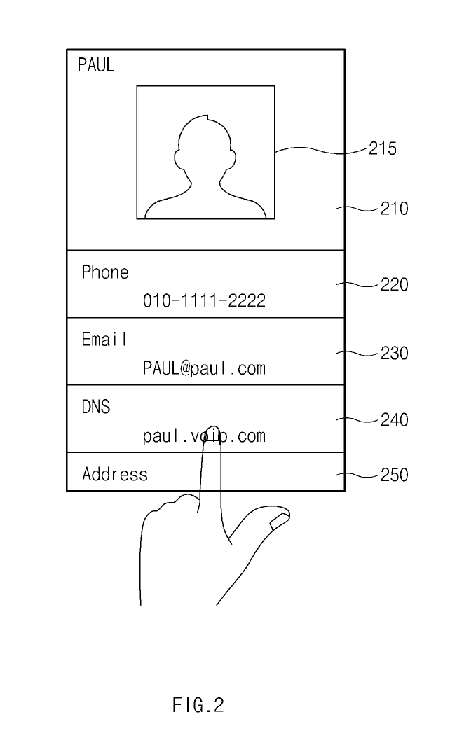

FIG. 2 illustrates a phone book application displayed on a screen of an electronic device 110 according to an embodiment of the present disclosure.

In FIG. 2, a user of the electronic device 110 selects PAUL from among a plurality of people registered in a phone book of the electronic device 110.

Referring to FIG. 2, the phone book application includes a plurality of fields indicating information about the selected contact PAUL. The plurality of fields include a name field 210, a photo field 215, a phone number field 220, an email field 230, a DNS name field 240, an address field 250, etc.

The DNS name field 240 may include a DNS name for PAUL's electronic device. PAUL's DNS name may be obtained in various ways. For example, the electronic device 110 may receive and obtain PAUL's DNS name directly selected from PAUL's contact information of the phone book application by its user.

As another example, the user may verify a DNS name written on PAUL's business card or may verify PAUL's DNS name written on a text message (e.g., a chat message, an SMS message, or an MMS message, etc.) received from PAUL, and may enter the verified PAUL's DNS name in the PAUL's DNS name field of the phone book application.

As another example, the electronic device 110 may obtain PAUL's DNS name included in a packet received to generate a session between the electronic device 110 and PAUL's electronic device. In this case, the electronic device 110 may map the obtained DNS name to PAUL's contact information and may automatically register PAUL's DNS name on the DNS name field 240 of the phone book application without a user input.

As another example, the electronic device 110 may receive a text message in which a DNS name is written. If the user verifies the text message, the electronic device 110 may display a pop-up window for registering a DNS name. In this case, if the user requests to register the DNS name in the pop-up window, the electronic device 110 may register PAUL's DNS name in the DNS name field 240 of the phone book application. The electronic device 110 may register PAUL's DNS name stored in the external server 130 in the DNS name field 240 of the phone book application 200 through synchronization, etc.

As shown in FIG. 2, if receiving a user input for touching or clicking on the DNS name field 240 from the user, the electronic device 110 may perform peer-to-peer communication with PAUL's electronic device (e.g., the other electronic device 120).

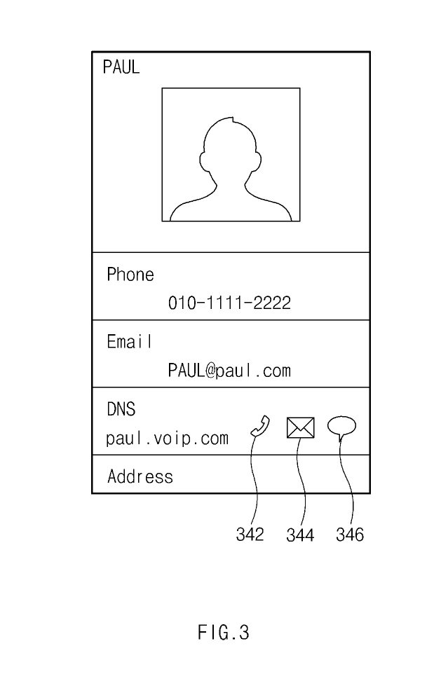

FIG. 3 illustrates a phone book application displayed on a screen of an electronic device according to an embodiment of the present disclosure.

Referring to FIG. 3, an object 342 of a phone receiver shape, an object 344 of a letter shape, and an object 346 of a speech bubble shape may be displayed on a DNS name field displayed on the phone book application.

A DNS name of PAUL's electronic device may be mapped to each of the objects 342, 344, and 346. Therefore, if receiving a user input for the object 342, the electronic device 110 may make a voice call (e.g., a voice over IP (VoIP)) or a video call with PAUL's electronic device according to peer-to-peer communication. Similarly, if receiving a user input for the object 344, the electronic device 110 may communicate a message with PAUL's electronic device according to peer-to-peer communication. Also, if receiving a user input for the object 346, the electronic device 110 may chat with PAUL's electronic device according to peer-to-peer communication.

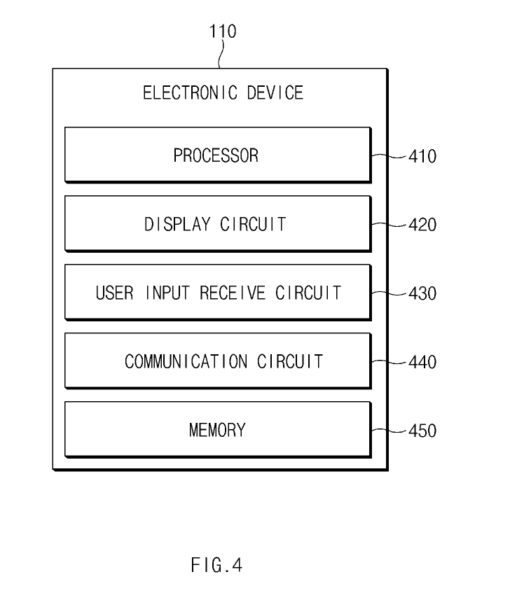

FIG. 4 illustrates an electronic device according to an embodiment of the present disclosure.

Referring to FIG. 4, the electronic device 110 includes a processor 410, a display circuit 420, a user input receive circuit 430, a communication circuit 440, and a memory 450. Various modifications are possible according to the components shown in FIG. 4. For example, the electronic device 110 may further include a user interface for receiving an instruction or information from a user of the electronic device 110. For example, the user interface may be an input device such as a keyboard or a mouse. Also, the user interface may be a graphic user interface (GUI) displayed on a screen of the electronic device 110.

The processor 410 may be implemented with, for example, a system on chip (SoC) and may include one or more of a central processing unit (CPU), a graphic processing unit (GPU), an image signal processor, an application processor (AP), or a communication processor (CP). The processor 410 may process and load an instruction or data, received from at least one other component (e.g., the display circuit 420, the user input receive circuit 430, and a communication circuit 440), into the memory 450 and may store various data in the memory 450.

The processor 410 may obtain a DNS name of another electronic device (e.g. the electronic device 120 of FIG. 1). As described with reference to FIG. 1, there may be various methods for obtaining the DNS name of the other electronic device 120. For example, the processor 410 may directly receive the DNS name of the other electronic device 120 from the user through a user input, the processor 410 may receive the DNS name of the other electronic device 120 from the other electronic device 120, or the processor 410 may obtain the DNS name of the other electronic device 120 from the external server 130 through synchronization.

Also, the processor 410 may execute a phone book application. A plurality of contact information (e.g., phone numbers of friends, colleagues, restaurants, and service centers) may be registered in the executed phone book application. Also, the processor 410 may newly add a ‘DNS name’ field to each of contact information to allow the user to enter a DNS name in the phone book application. The DNS name may be directly entered in the ‘DNS’ name field from the user of the electronic device 110 through a touch input or an external input device such as a keyboard. The processor 410 may receive the DNS name from the other electronic device 120 or the external server 130, through a text message, etc. In this case, the processor 410 may automatically register the DNS name in a ‘DNS’ name field of contact information of a user corresponding to the DNS name (e.g., a user of the other electronic device 120 or a user corresponding to the DNS name registered in the external server 130).

The processor 410 may have a selectable object or icon for performing a voice call service, a video call service, a message transmit or receive service, or a chat service, etc., using the DNS name, as well as the DNS name on the ‘DNS name’ field. The DNS name may be mapped with the selectable object or icon.

The processor 410 may further obtain state information about contact information registered in the phone book application. The state information may include states such as an online state, an offline state, an empty state, a calling state, a working state, a busy state, another working state.

The display circuit 420 may display a variety of content (e.g., an application execution screen, text, an image, a video, an icon, or a symbol, etc.) on a screen of the electronic device 110. The screen may include, for example, a liquid crystal display (LCD), a light emitting diode (LED) display, an organic LED (OLED) display, a microelectromechanical systems (MEMS) display, or an electronic paper display, etc.

The processor 410 may display an execution screen of the phone book application on the screen through the display circuit 420. A plurality of contact information may be displayed on the execution screen of the phone book application. Each of the plurality of contact information may include a ‘DNS name’ field together with user information or electronic device information. The DNS name and the selectable object or icon may be displayed on the ‘DNS name’ field. In addition, state information of each of the plurality of contact information may be further displayed on the execution screen of the phone book application.

The user input receive circuit 430 may process a user input received from the user. The user input may be a touch input using a finger or a stylus (e.g., an electronic pen) of the user. Also, the user input may include an input for providing an input through sensing of an electrical change although a finger or stylus of the user is not in direct contact with the screen, for example a hover input.

The processor 410 may receive a DNS name of the other electronic device 120 through the user input receive circuit 430. Also, the processor 410 may receive a user input for selecting the phone book application through the user input receive circuit 430. In addition, the processor 410 may receive a user input, for selecting a DNS name or a selectable object or icon of contact information displayed on the phone book application, through the user input receive circuit 430. In this case, the processor 410 may perform an operation stored in the memory 450, corresponding to a user input, according to the user input received through the user input receive circuit 430.

The communication circuit 440 may perform communication using a network (e.g. network 140 of FIG. 1). For example, an operation of obtaining a DNS name of the other electronic device 120 through the other electronic device 120 or the external server 130 by the processor 410 may be performed through the communication circuit 440. Also, an operation of performing peer-to-peer communication with the other electronic device 120 by the processor 410 may be performed through the communication circuit 440. The peer-to-peer communication may be performed through a transport control protocol (TCP) or a user datagram protocol (UDP). Herein, various embodiments of the present disclosure are not limited to performing the peer-to-peer communication through TCP or UDP. For example, the peer-to-peer communication may be performed through a new protocol which may be used in the future.

The memory 450 may store instructions for operations performed by the processor 410. In this case, data stored in the memory 450 may include data input and output between components included in the electronic device 110 and may include data input and output between the electronic device 110 and components outside the electronic device 110. For example, the memory 450 may store the phone book application and a plurality of contact information registered in the phone book application, etc.

The memory 450 may include an embedded memory or an external memory. The embedded memory may include, for example, at least one of a volatile memory (e.g., a dynamic random access memory (DRAM), a static RAM (SRAM), a synchronous dynamic RAM (SDRAM), etc.), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, etc.), a hard disk drive (HDD), or a solid state drive (SSD)).

The external memory may include a flash drive, for example, a compact flash (CF), a secure digital (SD), a micro-SD, a mini-SD, an extreme digital (xD), a multimedia card (MMC), or a memory stick, etc. The external memory may operatively and/or physically connect with the electronic device 110 through various interfaces.

It should be well understood to those skilled in the art that each of the processor 410, the display circuit 420, the user input receive circuit 430, the communication circuit 440, and the memory 450 is implemented to be independent of the electronic device 110. In addition, one or more of the processor 410, the display circuit 420, the user input receive circuit 430, the communication circuit 440, and the memory 450 may be integrated and implemented with each other.

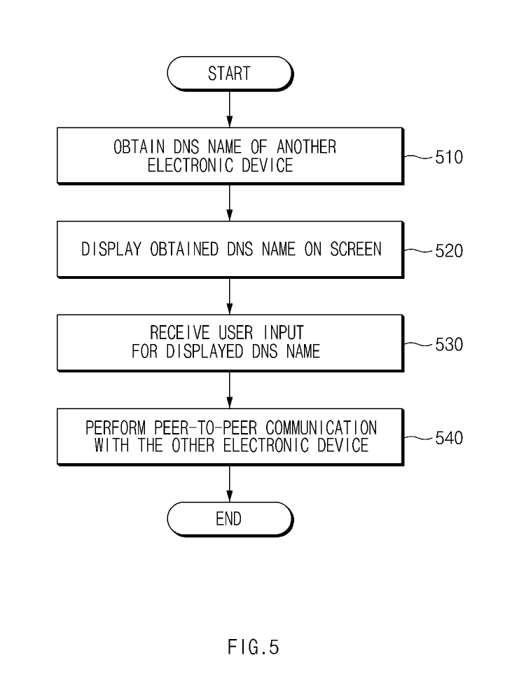

FIG. 5 is a flowchart illustrating a method for communicating with another electronic device using a DNS name according to an embodiment of the present disclosure.

Referring to FIG. 5, in step 510, the electronic device 110 of FIG. 1, obtains a DNS name of the other electronic device 120. The electronic device 110 may obtain the DNS name of the other electronic device 120 from a direct user input or externally.

In step 520, the electronic device 110 displays the DNS name obtained in step 510 on its screen. For example, the electronic device 110 may display the DNS name obtained in step 510 on a DNS name field of contact information registered in a phone book application.

In step 530, the electronic device 110 receives a user input for the DNS name displayed in step 520. For example, the electronic device 110 may receive a user input for selecting one of at least one or more selectable objects or icons displayed in the DNS name field.

In step 540, the electronic device 110 performs peer-to-peer communication with the other electronic device 120 according to the user input received in step 530. In this case, the electronic device 110 may perform the peer-to-peer communication by operating a TCP server through one port. The peer-to-peer communication may have differences in at least some of the schemes of the peer-to-peer communication according to the object or icon selected in step 530.

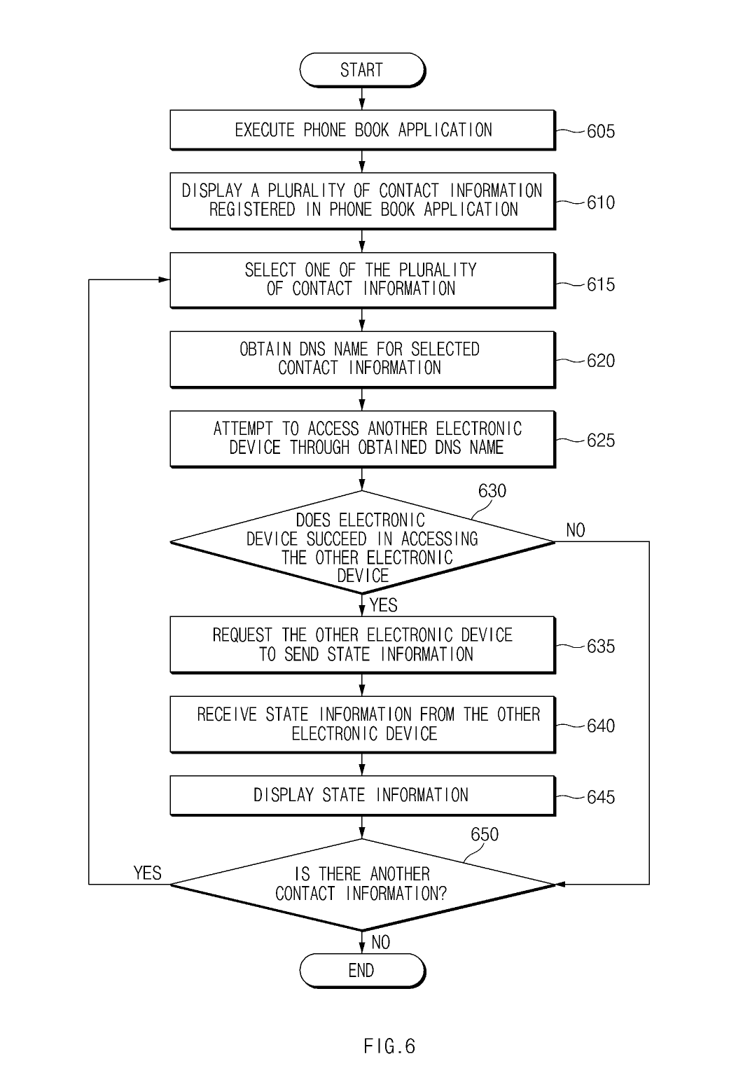

FIG. 6 is a flowchart illustrating a method for obtaining state information of another electronic device using a DNS name according to an embodiment of the present disclosure. Referring to FIG. 6, in step 605, the electronic device 110 of FIG. 1, executes a phone book application.

In step 610, the electronic device 110 displays a plurality of contact information from the phone book application executed in step 605.

In step 615, the electronic device 110 selects one of the plurality of contact information displayed in step 610. For example, an electronic device corresponding to the selected contact information is the other electronic device 120.

In step 620, the electronic device 110 obtains a DNS name for the contact information selected in step 615.

In step 625, the electronic device 110 attempts to access the other electronic device 120 through the DNS name obtained in step 620.

In step 630, the electronic device 110 verifies the result of attempting to access the other electronic device 120 in step 625. If succeeding in accessing the other electronic device 120, the method proceeds to step 635. If failing in accessing the other electronic device 120, the method proceeds to step 650.

In step 635, the electronic device 110 requests the other electronic device 120 to send state information.

In step 640, the electronic device 110 receives the state information of the other electronic device 120, requested in step 635, from the other electronic device 120.

In step 645, the electronic device 110 displays the state information of the other electronic device 120, received in step 640, on the phone book application.

In step 650, the electronic device 110 determines whether there is another contact information on which state information is not displayed. If there is the other contact information on which the state information is not displayed, the method proceeds to step 615. If there is no other contact information on which the state information is not displayed, the method ends.

Although step 605 to step 650 are illustrated separately and in series in FIG. 6, some of the above-described steps may be simultaneously performed, may be repeated at intervals of a predetermined time, or may be performed again according to a user input.

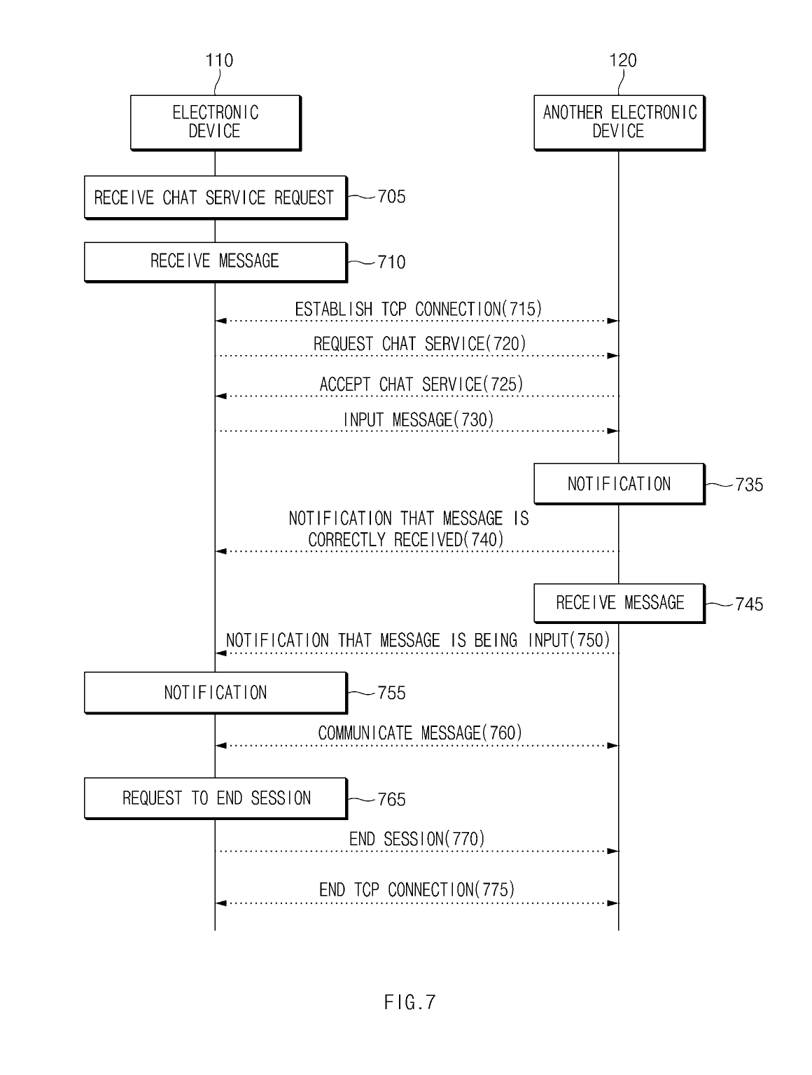

FIG. 7 is a signal flow diagram illustrating a method for performing a chat service with another electronic device using a DNS name according to an embodiment of the present disclosure.

Referring to FIG. 7, in step 705, an electronic device 110 receives a user input requesting a chat service, from a user. For example, the electronic device 110 may receive the user input, for requesting the chat service, through an operation of touching or selecting an object 346 located in a DNS name field as illustrated in FIG. 3 with which a DNS name of a counterpart who will be in contact with the user is mapped. Alternatively, if an icon of a chat service application, with which a DNS name is mapped, is generated on a screen of the electronic device 110, the electronic device 110 may receive a user input for touching or selecting the icon of the chat service application.

In step 710, the electronic device 110 receives a chat message from the user.

In step 715, the electronic device 110 and the other electronic device 120 establish a TCP connection for peer-to-peer communication.

In step 720, the electronic device 110 requests the other electronic device 120 to perform a chat service.

In step 725, the other electronic device 120 sends an acceptance message for the chat service requested in step 720 to the electronic device 110. If the other electronic device 120 declines the chat service or if there is no response during a predetermined time, the method proceeds with step 775.

In step 730, the electronic device 110 sends the chat message input in step 710 to the other electronic device 120.

In step 735, the other electronic device 120 receives the chat message sent in step 730 and informs its user of the received chat message.

In step 740, the other electronic device 120 sends the notification that the chat message sent in step 730 is correctly received to the electronic device 110. The notification may be provided if the other electronic device 120 verifies the chat message.

In step 745, the other the electronic device 120 receives a chat message to be sent to the electronic device 110.

In step 750, the other the electronic device 120 notifies the electronic device 110 that the chat message received in step 745 is being input.

In step 755, the electronic device 110 informs its user of an input state of the chat message of the other electronic device 120, which is notified in step 750.

In step 760, the electronic device 110 and the other electronic device 120 communicate a chat message with each other, e.g. perform operations as described in steps 730 to 755.

In step 765, the electronic device 110 receives' a request to end a session from the user of the electronic device 110. The request to end the session may be received as the user ends the chat service.

In step 770, the electronic device 110 sends a session end message to the other electronic device 120. In step 775, the TCP connection between the electronic device 110 and the electronic device 120 is ended.

Alternatively, some of the above-described steps 705 to 775 may be simultaneously performed, may be repeated at intervals of a predetermined time, or may be performed again according to a user input.

According to various embodiments of the present disclosure, an electronic device may include a processor configured to obtain a domain name system (DNS) name of another electronic device, a display circuit configured to display the DNS name on a screen of the electronic device, a user input receive circuit configured to receive a user input for the displayed DNS name, and a communication circuit configured to perform peer-to-peer communication with the other electronic device according to the user input.

According to various embodiments of the present disclosure, the processor may obtain the DNS name by receiving the DNS name from a user of the electronic device through the user input receive circuit.

According to various embodiments of the present disclosure, the processor may obtain the DNS name by receiving the DNS name from the other electronic device through the communication circuit.

According to various embodiments of the present disclosure, the processor may obtain the DNS name by receiving the DNS name from an external server through the communication circuit.

According to various embodiments of the present disclosure, the external server may include a communication company server, an electronic device manufacturer server, or an application server.

According to various embodiments of the present disclosure, the peer-to-peer communication may include at least one or more of an incoming or outgoing call service, a message transmit or receive service, or a chat service.

According to various embodiments of the present disclosure, the display circuit may display objects corresponding to the incoming or outgoing call service, the message transmit or receive service, and the chat service on the screen. The communication circuit may perform the peer-to-peer communication with the other electronic device according to a user input for one of the displayed objects corresponding to the incoming or outgoing call service, the message transmit or receive service, and the chat service.

According to various embodiments of the present disclosure, the display circuit may display state information of the other electronic device. The state information may include at least one or more of an online state, an offline state, an empty state, a calling state, a busy state, or another working state.

According to various embodiments of the present disclosure, the display circuit may display the DNS name on the screen by displaying the DNS name as contact information of the other electronic device in a phone book of the electronic device.

According to various embodiments of the present disclosure, an internet protocol (IP) address corresponding to the DNS name may be dynamically changed.

According to various embodiments of the present disclosure, a method performed in an electronic device may include obtaining a, domain name system (DNS) name of another electronic device, displaying the DNS name on a screen of the electronic device, receiving a user input for the displayed DNS name, and performing peer-to-peer communication with the other electronic device according to the user input.

According to various embodiments of the present disclosure, the performing of the peer-to-peer communication with the other electronic device may include performing at least one of an incoming or outgoing call service, a message transmit or receive service, or a chat service with the other electronic device.

According to various embodiments of the present disclosure, the method may further include displaying objects corresponding to the incoming or outgoing call service, the message transmit or receive service, and the chat service on the display screen. In this case, the receiving of the user input for the displayed DNS name may include receiving a user input for one of the displayed objects corresponding to the incoming or outgoing call service, the message transmit or receive service, and the chat service.

According to various embodiments of the present disclosure, an internet protocol (IP) address corresponding to the DNS name may be dynamically changed.

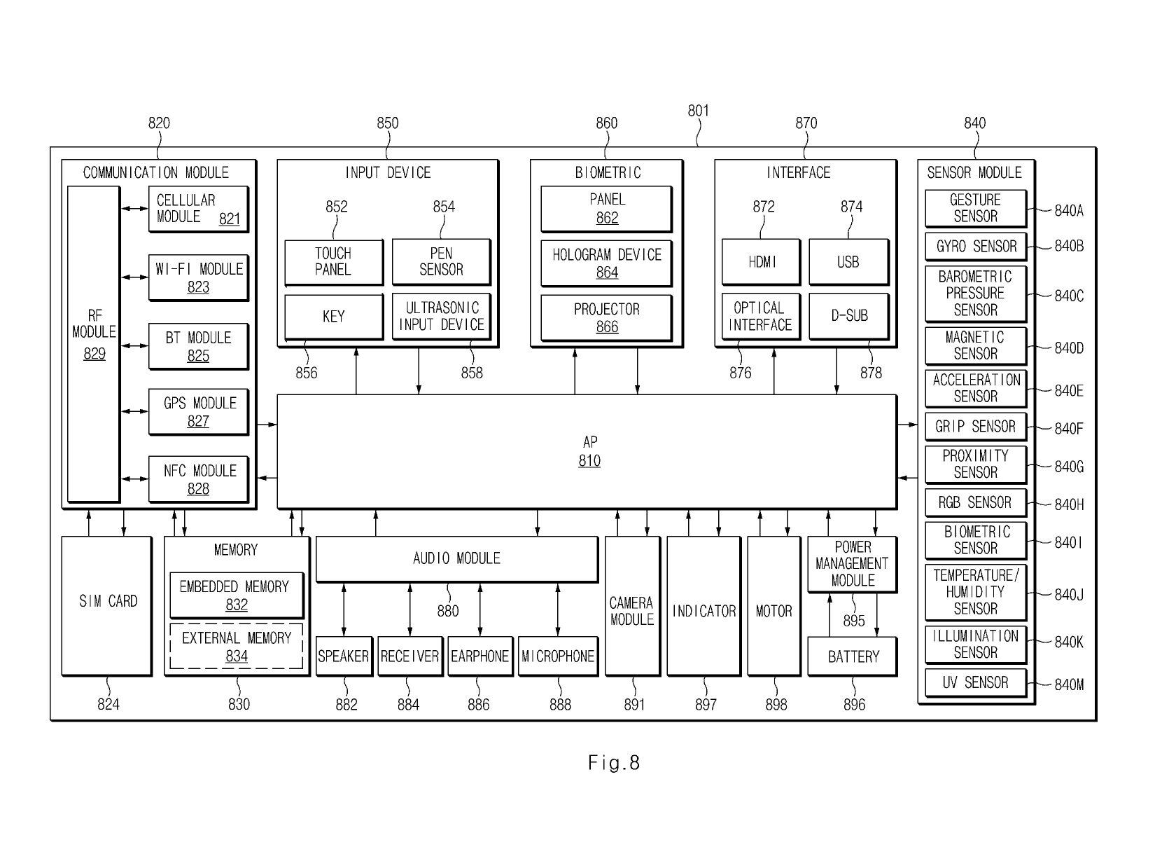

FIG. 8 illustrates a configuration of an electronic device according to an embodiment of the present disclosure.

Referring to FIG. 8, the electronic device 801 includes an application processor (AP) 810, a communication module 820, a subscriber identification module (SIM) card 824, a memory 830, a sensor module 840, an input device 850, a display 860, an interface 870, an audio module 880, a camera module 891, a power management module 895, a battery 896, an indicator 897, and a motor 898.

The AP 810 may drive, for example, an operating system (OS) or an application program to control a plurality of hardware or software components connected thereto and may process and compute a variety of data. The AP 810 may be implemented with, for example, a system on chip (SoC). The AP 810 may further include a graphic processing unit (GPU).

The communication module 820 may communicate data between the electronic device 801 and another electronic device connected over a network. The communication module 820 includes the cellular module 821, a wireless-fidelity (Wi-Fi) module 823, a Bluetooth (BT) module 825, a global positioning system (GPS) module 827, a near field communication (NFC) module 828, and a radio frequency (RF) module 829.

The cellular module 821 may provide, a voice call service, a video call service, a text message service, or an Internet access service, etc., through a communication network (e.g., LTE, LTE-A, CDMA, WCDMA, UMTS, WiBro, or GSM, etc.). Also, the cellular module 821 may identify and authenticate, for example, the electronic device 801 in a communication network using a SIM (e.g., the SIM card 824). The cellular module 821 may perform at least some of functions which may be provided by the AP 810. For example, the cellular module 821 may perform at least part of a multimedia control function.

The cellular module 821 may include a communication processor (CP). Also, the cellular module 821 may be implemented with, for example, an SoC. In FIG. 8, the cellular module 821 (e.g., a CP), the memory 830, the power management module 895, etc., are independent of the AP 810. However, the AP 810 may be implemented to include at least some (e.g., the cellular module 821) of the above-mentioned components.

The AP 810 or the cellular module 821 (e.g., the CP) may load an instruction or data, received from at least one of a non-volatile memory or another component connected thereto, into a volatile memory to process the instruction and data. Also, the AP 810 or the cellular module 821 may store data, received from at least one of other components or generated by at least one of the other components, in a non-volatile memory.

The Wi-Fi module 823, the BT module 825, the GPS module 827, or the NFC module 828 may include, for example, a processor for processing data transmitted and received through the corresponding module. In FIG. 8, the cellular module 821, the Wi-Fi module 823, the BT module 825, the GPS module 827, and the NFC module 828 are independent of each other. However, at least some (e.g., two or more) of the cellular module 821, the Wi-Fi module 823, the BT module 825, the GPS module 827, or the NFC module 828 may be included in one integrated chip (IC) or one IC package. For example, at least some (e.g., a CP corresponding to the cellular module 821 and a Wi-Fi processor corresponding to the Wi-Fi module 823) of processors corresponding to the cellular module 821, the Wi-Fi module 823, the BT module 825, the GPS module 827, and the NFC module 828 may be implemented with one SoC.

The RF module 829 may communicate data, for example, an RF signal. The RF module 829 may include, for example, a transceiver, a power amplifier module (PAM), a frequency filter, or a low noise amplifier (LNA), etc. Also, the RF module 829 may further include components, for example, conductors or wires, etc., for communicating radio waves in free space upon performing wireless communication. In FIG. 8, the cellular module 821, the Wi-Fi module 823, the BT module 825, the GPS module 827, and the NFC module 828 share the one RF module 829 with each other. However, according to an embodiment of the present disclosure, at least one of the cellular module 821, the Wi-Fi module 823, the BT module 825, the GPS module 827, or the NFC module 828 may communicate an RF signal through a separate RF module.

The SIM card 824 may be inserted into a slot formed in a specific position of the electronic device 801. The SIM card 824 may include unique identification information (e.g., an integrated circuit card identifier (ICCID)) or subscriber information (e.g., an international mobile subscriber identity (IMSI)).

The memory 830 (e.g., a memory 450 of FIG. 4) includes an embedded memory 832 or an external memory 834. The embedded memory 832 may include at least one of, for example, a volatile memory (e.g., a dynamic random access memory (DRAM), a static RAM (SRAM), a synchronous dynamic RAM (SDRAM), etc.), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory, etc.).

The embedded memory 832 may be a solid state drive (SSD). The external memory 834 may include a flash drive, for example, a compact flash (CF), a secure digital (SD), a micro-SD, a mini-SD, an extreme digital (xD), or a memory stick, etc. The external memory 834 may operatively connect with the electronic device 801 through various interfaces. The electronic device 801 may further include a storage device (or a storage medium) such as a hard drive:

The sensor module 840 may measure, for example, a physical quantity or may detect an operation state of the electronic device 801, and may convert the measured or detected information to an electric signal. The sensor module 840 includes a gesture sensor 840A, a gyro sensor 840B, a barometric pressure sensor 840C, a magnetic sensor 840D, an acceleration sensor 840E, a grip sensor 840F, a proximity sensor 840G, an RGB sensor 840H (e.g., red, green, blue (RGB) sensor), a biometric sensor 840I, a temperature/humidity sensor 840J, an illumination sensor 840K, or an ultraviolet (UV) sensor 840M. Additionally or alternatively, the sensor module 840 may include, for example, an e-nose sensor, an electromyography (EMG) sensor, an electroencephalogram (EEG) sensor, an electrocardiogram (ECG) sensor, an infrared (IR) sensor, an iris sensor, or a fingerprint sensor, etc. The sensor module 840 may further include a control circuit for controlling at least one or more sensors included therein.

The input device 850 includes a touch panel 852, a (digital) pen sensor 854, a key 856, or an ultrasonic input unit 858. The touch panel 852 may recognize a touch input using at least one of, for example, a capacitive detecting method, a resistive detecting method, an infrared detecting method, or an ultrasonic detecting method. Also, the touch panel 852 may further include a control circuit. In case of the capacitive detecting method, the touch panel 852 may recognize physical contact or proximity. The touch panel 852 may further include a tactile layer. In this case, the touch panel 852 may provide a tactile reaction to a user.

The (digital) pen sensor 854 may be implemented, using, for example, the same or similar method as a method of receiving a touch input of the user or a separate sheet for recognition. The key 856 may include, for example, a physical button, an optical key, or a keypad. The ultrasonic input unit 858 may allow the electronic device 801 to detect a sound wave using a microphone 888 and to verify data through an input tool generating an ultrasonic signal. The ultrasonic input unit 858 may perform wireless recognition. The electronic device 801 may receive a user input from an external device (e.g., a computer or a server), connected with the communication module 820, using the communication module 820.

The display 860 includes a panel 862, a hologram device 864, or a projector 866.

The panel 862 may be, for example, a liquid-crystal. display (LCD) or an active-matrix organic light-emitting diode (AM-OLED), etc. The panel 862 may be implemented to be, for example, flexible, transparent, or wearable. The panel 862 and the touch panel 852 may be integrated into one module. The hologram device 864 may show a stereoscopic image in a space using interference of light. The projector 866 may project light onto a screen to display an image. The screen may be positioned, for example, inside or outside the electronic device 801. The display 860 may further include a control circuit for controlling the panel 862, the hologram device 864, or the projector 866.

The interface 870 may include, for example, a high-definition multimedia interface (HDMI) 872, a universal serial bus (USB) 874, an optical interface 876, or a D-subminiature 878. Additionally or alternatively, the interface 870 may include, for example, a mobile high definition link (MHL) interface, an SD card/multimedia card (MMC) interface, or an infrared data association (IrDA) standard interface.

The audio module 880 may convert a sound and an electric signal in bidirectionally. The audio module 880 may process sound information input or output through, for example, a speaker 882, a receiver 884, an earphone 886, or the microphone 888, etc.

The camera module 891 may be a device which captures a still image and a moving image. The camera module 891 may include one or more image sensors (e.g., a front sensor or a rear sensor), a lens, an image signal processor (ISP), or a flash (e.g., an LED or a xenon lamp).

The power management module 895 may manage, for example, power of the electronic device 801. The power management module 895 may include a power management integrated circuit (PMIC), a charger IC, or a battery or fuel gauge.

The PMIC may be implemented in, for example, an integrated circuit or an SoC semiconductor. A charging method may be classified into a wired charging method and a wireless charging method. The charger IC may charge the battery 896 and may prevent overvoltage or overcurrent from flowing in from a charger. The charger IC may include a charger IC for at least one of the wired charging method or the wireless charging method.

The wireless charging method may include, for example, a magnetic resonance method, a magnetic induction method, or an electromagnetic method, etc. An additional circuit for wireless charging, for example, a coil loop, a resonance circuit, or a rectifier, etc., may be further provided.

The battery gauge may measure, for example, the remaining capacity of the battery 896 and voltage, current, or temperature thereof while the battery 896 is charged. The battery 896 may store or generate electricity and may supply power to the electronic device 801 using the stored or generated electricity. The battery 896 may include, for example, a rechargeable battery or a solar battery.

The indicator 897 may display a specific state of the electronic device 801 or part (e.g., the AP 810) thereof, for example, a booting state, a message state, or a charging state, etc. The motor 898 may convert an electric signal into mechanical vibration. The electronic device 801 may include a processing unit (e.g., a GPU) for supporting mobile TV. The processing unit for supporting mobile TV may process media data according to standards, for example, a digital multimedia broadcasting (DMB) standard, a digital video broadcasting (DVB) standard, or a MediaFlo™ standard, etc.

The term “circuit” as used herein may refer to, for example, a unit including one of hardware, software, and firmware or two or more combinations thereof. The term “circuit” may be interchangeably used with, for example, the terms “unit”, “logic”, “logical block”, “component”, or “module”, etc. A “circuit” may be a minimum unit of an integrated component or a part thereof. A “circuit” may be a minimum unit performing one or more functions or a part thereof. A “circuit” may be mechanically or electronically implemented. For example, a “circuit” may include at least one of an application-specific integrated circuit (ASIC) chip, field-programmable gate arrays (FPGAs), or a programmable-logic device, which is well known or will be developed in the future, for performing certain operations.

At least part of a device (e.g., modules or the functions) or a method (e.g., operations) may be implemented with, for example, instructions stored in computer-readable storage media which have a program module. When the instructions are executed by a processor (e.g., an AP 810 of FIG. 8), one or more processors may perform functions corresponding to the instructions. The computer-readable storage media may be, for example, a memory 830 of FIG. 8.

According to various embodiments of the present disclosure, computer-readable storage media store instructions executed by at least one processor. The instructions are set to obtain a domain name system (DNS) name of another electronic device, to display the DNS name on a screen of an electronic device, to receive a user input for the displayed DNS name, and to perform peer-to-peer communication with the other electronic device according to the user input.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory), etc. Also, the program instructions may include not only mechanical codes compiled by a compiler but also high-level language codes which may be executed by a computer using an interpreter etc. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included therein. Operations executed by modules, program modules, or other elements may be executed by a successive method, a parallel method, a repeated method, or a heuristic method. Also, some of the operations may be executed in a different order or may be omitted, and other operations may be added.

According to various embodiments of the present disclosure, the electronic device may communicate with a counterpart electronic device without a log-in operation through a separate server by communicating with the counterpart electronic device through a DNS name of the counterpart electronic device.

According to various embodiments of the present disclosure, the electronic device may perform communication with a counterpart electronic device without the communication passing through a separate server, thus communicating data without paying additional network access fees.

Embodiments of the present disclosure described and shown in the drawings are provided as examples to describe technical content and help understanding but do not limit the scope of the present disclosure. Accordingly, it should be interpreted that besides the embodiments listed herein, all modifications or modified forms derived based on the technical ideas of the present disclosure are included in the scope of the present disclosure as defined in the claims, and their equivalents.

What is claimed is:

1. An electronic device, comprising:
a processor configured to obtain a domain name system (DNS) name of another electronic device;
a display circuit configured to display the DNS;
a user input receive circuit configured to receive a user input associated with the displayed DNS name; and
a communication circuit configured to perform peer-to-peer communication with the other electronic device based on the user input.

2. The electronic device of claim 1, wherein the processor is further configured to obtain the DNS name by receiving the DNS name from a user of the electronic device through the user input receive circuit.

3. The electronic device of claim 1, wherein the processor is further configured to obtain the DNS name by receiving the DNS name from the other electronic device through the communication circuit.

4. The electronic device of claim 1, wherein the processor is further configured to obtain the DNS name by receiving the DNS name from an external server through the communication circuit.

5. The electronic device of claim 4, wherein the external server comprises at least one of a communication company server, an electronic device manufacturer server, and an application server.

6. The electronic device of claim 1, wherein the peer-to-peer communication comprises at least one of an incoming call service, an outgoing call service, a message transmit service, a message receive service, and a chat service with the other electronic device.

7. The electronic device of claim 6, wherein the display circuit displays objects corresponding to at least one of the incoming call service, the outgoing call service, the message transmit service, the message receive service, and the chat service, and
wherein the communication circuit performs the peer-to-peer communication with the other electronic device based on a user input associated with one of the displayed objects corresponding at least one of the incoming call service, the outgoing call service, the message transmit service, the message receive service, and the chat service.

8. The electronic device of claim 7, wherein the display circuit displays state information of the other electronic device, and
wherein the state information comprises at least one of an online state, an offline state, an empty state, a calling state, a busy state, and another working state.

9. The electronic device of claim 1, wherein the display circuit displays the DNS name as contact information of the other electronic device in a phone book of the electronic device.

10. The electronic device of claim 1, wherein an internet protocol (IP) address corresponding to the DNS name is dynamically changed.

11. A method performed in an electronic device: the method comprising:
obtaining a domain name system (DNS) name of another electronic device;
displaying the DNS name on the electronic device;
receiving a user input associated with the displayed DNS name; and
performing peer-to-peer communication with the other electronic device based on the user input.

12. The method of claim 11, wherein performing the peer-to-peer communication with the other electronic device comprises:
performing at least one of an incoming call service, an outgoing call service, a message transmit service, a message receive service, and a chat service with the other electronic device.

13. The method of claim 11, further comprising:
displaying objects corresponding to at least one of an incoming call service, an outgoing call service, a message transmit service, a message receive service, and a chat service on the screen,
wherein receiving the user input for the displayed DNS name comprises:
receiving a user input associated with one of the displayed objects corresponding to at least one of the incoming call service, the outgoing call service, the message transmit service, the message receive service, and the chat service.

14. The method of claim 11, wherein an internet protocol (IP) address corresponding to the DNS name is dynamically changed.

15. A non-transitory computer-readable recording medium in an electronic device storing thereon instructions, which when executed by at least one processor instruct the electronic device to:
obtain a domain name system (DNS) name of another electronic device:
display the DNS name on a screen of an electronic device;
receive a user input associated with the displayed DNS name; and
perform peer-to-peer communication with the other electronic device based on the user input.
